(19) United States
(12) Patent Application Publication
(10) Pub. No.: US 2010/0145994 A1
(43) Pub. Date: Jun. 10, 2010

(54) SERVICE RECOMMENDATION SYSTEM, OPERATING METHOD THEREOF, AND DEVICE CONTAINING COMPUTER SOFTWARE

(75) Inventors: Ching-Pao CHANG, Kaohsiung County (TW); Chi-Lu YANG, Tainan County (TW); Chih-Ping CHU, Tainan City (TW); Yeim-Kuan CHANG, Hsinchu City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: INSTITUTE FOR INFORMATION INDUSTRY, Taipei City (TW)

(21) Appl. No.: 12/343,071

(22) Filed: Dec. 23, 2008

(30) Foreign Application Priority Data
Dec. 8, 2008 (TW) 097147635

(51) Int. Cl. G06F 17/30; G06K 19/00

(52) U.S. Cl. 707/781; 726/21; 707/E17.001

(57) ABSTRACT

A service recommendation system, an operating method thereof, and a device containing computer software are provided. The system includes a label module, a service equipment, and a server device. The label module having an ID data of the user is carried by a user. The service equipment has a detection module and a control interface. The detection module obtains and outputs the ID data. The server device includes a database, a determination module, and a service setting module. The database stores a standard model and a user model. The determination module matches the ID data to the database. When the user model corresponding to the ID data exists in the database, the service setting module sets an operating mode according to the user model. When the user model corresponding to the ID data does not exist, the service setting module sets an operating mode according to the standard model.

### CROSS-REFERENCE TO RELATED APPLICATION

This application claims the benefit of Taiwan Patent Application No. 097147635, filed on Dec. 8, 2008, which is hereby incorporated by reference for all purposes as if fully set forth herein.

### BACKGROUND OF THE INVENTION

1. Field of Invention

The present invention relates to a service recommendation system, an operating method thereof and a device containing computer software for executing the same, and more particularly to a service recommendation system, an operating method thereof, and a device containing computer software capable of automatically recommending a personalized service.

2. Related Art

Currently, various types of service equipment are available on market, for example, fitness equipments such as treadmills, weight lifting equipment, and elliptical trainers. These equipment may be operated by a user by selecting a desired service item provided thereon. For example, a user sets a pre-warm up, warm up, or race mode and a time span thereof among the operating modes of a treadmill, so as to perform a corresponding service process of walking, jogging, or fast running.

However, the service equipment has to be reset manually when the user finishes exercising on this machine and intends to set the same parameters or other related parameters the next time. Further, the habits of using service equipment vary among different users upon individual demands or preferences. As for the treadmill, each user has a specific set mode. Therefore, it is rather inconvenient for the user to spend time in manually setting the service equipment every time.

### SUMMARY OF THE INVENTION

In order to solve the above problems, the present invention is directed to a service recommendation system, an operating method thereof, and a device containing computer software, capable of obtaining a user model and a standard model matching an identification (ID) data of a user from a database of a server device, so as to provide a personalized service according to the user model and the standard model.

Therefore, a method of operating a service recommendation system is provided. The method includes obtaining an ID data of a user from at least one service equipment, and transmitting the ID data to a server device by the service equipment; matching the ID data to a database by the server device; when a user model corresponding to the ID data exists in the database, creating at least one service setting parameter by the server device according to the user model, so as to set an operating mode of the service equipment; and when a user model corresponding to the ID data does not exist in the database, creating at least one service setting parameter by the server device according to at least one standard model, so as to set an operating mode of the service equipment.

The method of the present invention may be implemented by a recording media or a device containing computer software. Besides, the recording media or the device containing computer software may be loaded and executed by an electronic device, such as a computer, so as achieve the above mentioned functions.

Further, a service recommendation system including a label module, at least one service equipment, and at least one server device is also provided.

The label module having an ID data of a user is carried by the user. The service equipment has a detection module and a control interface for controlling an operating mode parameter of the service equipment. The detection module obtains and outputs the ID data of the user. The server device includes a database, a determination module, and a service setting module. The database stores at least one standard model and at least one user model. The determination module receives the ID data obtained by the detection module, and matches the ID data to the database. When the user model corresponding to the ID data exists in the database, the service setting module creates at least one service setting parameter according to the user model so as to set an operating mode of the service equipment. When the user model corresponding to the ID data does not exist in the database, the service setting module creates the service setting parameter according to the standard model so as to set an operating mode of the service equipment.

The present invention achieves the following efficacies.

The user obtains an ID data through a detection module of the service equipment, and determines whether the database of the server device contains the user model corresponding to the ID data. If the corresponding user model does exist, the service equipment provides a personalized service suitable for the user to adopt the operating mode of the service equipment according to the user model; otherwise, a standard model is provided based on average information created according to a plurality of conditions, such as physiological measurement signals, health condition information, ages, and genders of users who have used the service equipment. Therefore, when the user uses the service equipment for the first time, the service equipment may provide a personalized service suitable for the user to adopt the operating mode of the service equipment according to the standard model.

### BRIEF DESCRIPTION OF THE DRAWINGS

The present invention will become more fully understood from the detailed description given herein below for illustration only, and thus are not limitative of the present invention, and wherein:

FIG. 1 is a system architectural view of the present invention; and

FIG. 2 is a schematic flow chart of the present invention.

### DETAILED DESCRIPTION OF THE INVENTION

In order to make the aforementioned and other objectives, features, and advantages of the present invention comprehensible, embodiments accompanied with figures are described in detail below.

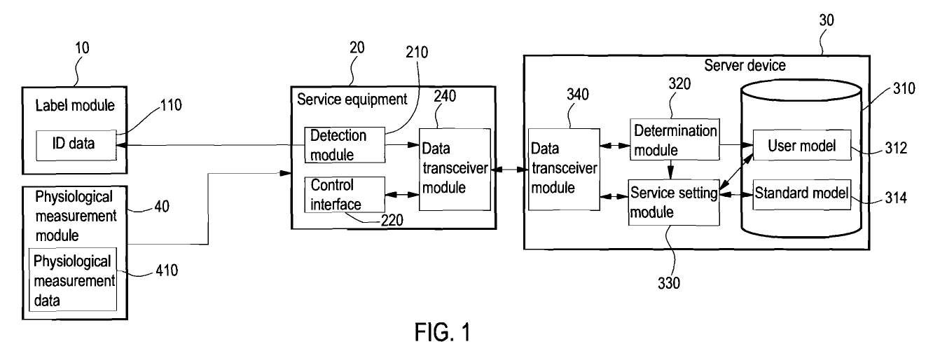

FIG. 1 is a system architectural view of the present invention. Referring to FIG. 1, the service recommendation system of the present invention includes a label module 10, a physiological measurement module 40, at least one service equipment 20, and at least one server device 30.

The label module 10 is carried by a user, and contains an identification (ID) data 110 of the user. The physiological measurement module 40 is carried by the user, and measures a physiological measurement data 410 such as the pulse, heart beat, and blood pressure of the user.

The service equipment 20 includes a detection module 210, a data transceiver module 240, and a control interface 220 for controlling an operating mode parameter of the service equipment 20. The detection module 210 detects to obtain the ID data 110 and the physiological measurement data 410 of the user, and outputs the ID data 110 and the physiological measurement data 410 to the data transceiver module 240 for transmission.

The server device 30 includes a data transceiver module 340, a database 310, a determination module 320, and a service setting module 330. The database 310 stores at least one standard model 314 and at least one user model 312. The data transceiver module 340 receives and outputs the ID data 110 and the physiological measurement data 410 to the determination module 320. The determination module 320 matches the ID data 110 and the physiological measurement data 410 to the database 310. When the database 310 contains the user model 312 corresponding to the ID data 110 and the physiological measurement data 410, the determination module 320 imports the user model 312 into the service setting module 330. The service setting module 330 creates at least one service setting parameter according to the user model 312, and the data transceiver module 340 transmits the service setting parameter to the service equipment 20, such that the control interface 220 can set an operating mode of the service equipment 20.

When the database 310 does not contain the user model 312 corresponding to the ID data 110, the service setting module 330 creates a service setting parameter according to the standard model 314, so as to set an operating mode of the service equipment 20.

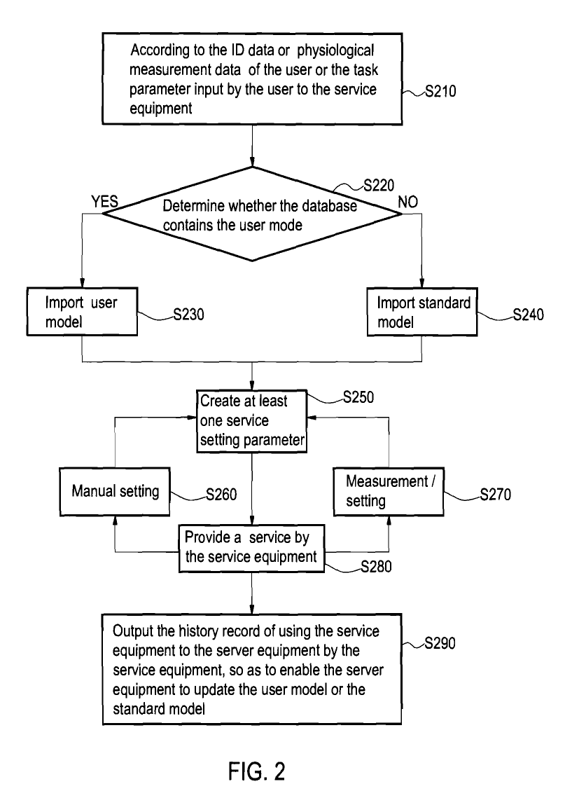

FIG. 2 is a schematic flow chart of the present invention. Referring to FIG. 2 together, when the user uses a service equipment 20, the detection module 210 of the service equipment 20 detects to obtain the ID data 110 of the user and further obtain a user parameter through the label module 10 carried by the user (Step S210). The user parameter is the physiological measurement data 410 of the physiological measurement module 40 and a task parameter input by the user through the service equipment 20.

Next, the service equipment 20 transmits the ID data 110, the physiological measurement data 410, and the task parameter to the determination module 320 of the server device 30. The physiological measurement module 40 may also be disposed on the service equipment 20 to perform the measurement when the service equipment 20 is used by the user.

On receiving the ID data 110, the physiological measurement data 410, and the task parameter, the determination module 320 of the server device 30 analyzes to determine whether the database 310 contains the user model 312 corresponding to the ID data 110, the physiological measurement data 410, and the task parameter (Step S220), and if yes, the determination module 320 imports the information about the user model 312 to the service setting module 330 (Step S230); otherwise, the determination module 320 imports the information about the standard model 314 to the service setting module 330 (Step S240).

The user model 312 is the information pre-stored in the database 310, such as a history record of the user using the service equipment 20 (for example, the daily, weekly, monthly, or yearly use frequency and a particular operating mode of the service equipment 20 habitually), a physiological measurement signal, a health condition information (for example, diseases of the user), an age, and a gender of the user. The standard model 314 is established based on average values of the information, such as the physiological measurement signals, health condition information, ages, and genders of users who have used the service equipment 20 and the history record of the users using the service equipment 20.

Thereafter, the service setting module 330 creates at least one service setting parameter according to the user model 312 (Step S250), and the control interface 220 of the service equipment 20 sets an operating mode of the service equipment 20 based on the service setting parameter, such that the service equipment 20 provides a personalized service for the user (Step S280).

Similarly, the service setting module 330 automatically adjusts the operating mode of the service equipment 20 through the control interface 220 according to the standard model 314, such that the user can operate the service equipment 20 easily when using the service equipment 20 for the first time.

Further, in order to meet the user's requirements, if the user thinks the user model 312 and the standard model 314 are not suitable for the current physiological status when using the service equipment 20, the user may initiatively set an operating mode of the service equipment 20 through the control interface 220 manually (Step S260). Moreover, during the use of the service equipment 20, the physiological measurement module 40 continuously measures the physiological status of the user so as to modify the equipment setting parameter (Step S270) for the control interface 220 and the execution time of the service setting parameter. After being used, the service equipment 20 transmits the use history of the user to the server device 30 through the data transceiver module 240, and stores the use history in the database 310, such that the server device 30 can update the user model 312 or the standard model 314 (Step S290). Thereby, the user is enabled to retrieve the user model 312 or the standard model 314 from the database 310 according to the use history when using the service equipment 20 for the next time, such that a personalized service is provided for the user in using the service equipment 20.

Therefore, the service setting module 330 automatically adjusts the operating mode of the service equipment 20 through the control interface 220 according to the user model 312 or the standard model 314 containing personal information about the user, and thus the service equipment 20 can provide a personalized service.

In the service recommendation system, the operating method thereof, and a device containing computer software provided by the present invention, the service equipment 20 is applicable to a fitness equipment such as treadmills, weight lifting equipment, and elliptical trainers. Here, a treadmill is taken as an embodiment below.

When a user uses the treadmill, the treadmill may obtain the user ID data 110 and the user physiological measurement data 410 from the label module 10 and the physiological measurement module 40 carried by the user through the detection module 210. The physiological measurement data 410 includes, for example, the pulse, heart beat, and blood pressure of the user.

When starting to use the treadmill, the user inputs a desired service item and task parameter of the treadmill through the control interface 220. Then, the detection module 210 of the treadmill transmits the information about the ID data 110, the physiological measurement data 410, and the task parameter of the treadmill input by the user to the server device 30 through the data transceiver module 240 on the treadmill. The data transceiver module 340 of the server device 30 receives and outputs the above information to the determination module 320, and the determination module 320 determines whether the database 310 contains the corresponding user model 312.

The user model 312 is an information pre-stored in the database 310, such as a history record of the user using the treadmill, for example, the daily, weekly, monthly, or yearly use frequency and a particular operating mode of the treadmill habitually (walking, jogging, or fast running), a physiological measurement signal (for example, pulse, heart beat, and blood pressure), a health condition information (for example, diseases of the user), an age, and a gender of the user.

If the user model 312 suitable for the user exists, the service setting module 330 creates at least one service setting parameter, and the data transceiver module 340 returns the parameter to the data transceiver module 240 of the treadmill, such that the control interface 220 sets an operating mode of the treadmill according to the service setting parameter. Thus, the treadmill provides a personalized service suitable for the habitual usage of the user.

If the user model 312 does not exist, the information about the standard model 314 is imported into the service setting module 330. The standard model 314 is established based on average values of the information, such as the physiological measurement signals, health condition information, ages, and genders of users who have used the treadmill and the history record of the users using the treadmill.

The service setting module 330 creates at least one service setting parameter according to the standard model 314, and the data transceiver module 340 returns the parameter to the data transceiver module 240 of the treadmill, such that the control interface 220 sets the operating mode of the treadmill according to the service setting parameter. Thus, the standard model 314 is adopted when the user uses the treadmill for the first time, and then the history record of the user when he/she uses the treadmill every time is stored in the database 310 so as to gradually construct the user model 312 suitable for the user.

Further, in order to meet the user's requirements, when the user thinks the user model 312 and the standard model 314 are not suitable for the current physiological status in using the treadmill, the user may initiatively set an operating mode of the treadmill through the control interface 220 manually. Moreover, during the use of the treadmill, the physiological measurement module 40 continuously measures the physiological status of the user so as to modify the setting parameter of the treadmill of the control interface 220 and the execution time of the service setting parameter. After the user uses the treadmill, the treadmill transmits the use history of the user to the server device 30 through the data transceiver module 240, and stores the use history in the database 310 for updating the user model 312 or the standard model 314 by the server device 30. Thus, when using the treadmill for the next time, the user is enabled to retrieve the user model 312 or the standard model 314 from the database 310 according to the use history, such that a personalized service is provided for the user in using the treadmill.

Therefore, the service setting module 330 automatically adjusts the operating mode of the treadmill through the control interface 220 according to the user model 312 or the standard model 314 containing personal information about the user, and thus the treadmill can provide a personalized service.

As described above, the service recommendation system, the operating method thereof, and the device containing computer software provided by the present invention have the following characteristics.

The user obtains the ID data, physiological measurement data, and task parameter input by the user to the service equipment through a detection module of the service equipment, and determines whether the database of the server device contains the user model corresponding to the ID data. If the required user model does exist, the service equipment provides a personalized service suitable for the user to use the operating mode of the service equipment according to the user model; otherwise, a standard model is provided based on average information created according to a plurality of conditions, such as physiological measurement signals, health condition information, ages, and genders of users who have used the service equipment. Therefore, when the user uses the service equipment for the first time, the service equipment may provide a personalized service suitable for the user to use the operating mode of the service equipment according to the standard model. Then, through continuous update after use each time, the standard model gradually forms a user model with personal information, such that the service equipment may automatically provide the user with the personalized service when the user uses the service equipment for the next time.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for operating a service recommendation system, comprising:
obtaining an identification (ID) data of a user and transmitting the ID data to a server device by at least one service equipment;
matching the ID data to a database by the server device;
when a user model corresponding to the ID data exists in the database, creating at least one service setting parameter by the server device according to the user model, so as to set an operating mode of the service equipment; and
when a user model corresponding to the ID data does not exist in the database, creating at least one service setting parameter by the server device according to at least one standard model, so as to set an operating mode of the service equipment.

2. The method for operating a service recommendation system according to claim 1, wherein the server device generates the service setting parameter according to at least one condition contained in the user model of the database, and the condition comprises a history record of the user using the service equipment, a physiological measurement signal, a health condition information, an age, and a gender of the user.

3. The method for operating a service recommendation system according to claim 2, wherein the condition is pre-stored in the database.

4. The method for operating a service recommendation system according to claim 1, wherein the standard model is established based on average values of information related to a physiological measurement signal, a health condition information, an age, and a gender of users who have used service equipment and history records of the users using the service equipment.

5. The method for operating a service recommendation system according to claim 1, wherein when the operating mode is enabled, the user initiatively sets the service setting parameter or a standard setting parameter so as to adjust the operating mode of the service equipment.

6. The method for operating a service recommendation system according to claim 1, wherein after the user uses the service equipment, the service equipment returns a history record of the operating mode to the server device, and the server device updates the user model and the standard model according to the history record.

7. The method for operating a service recommendation system according to claim 1, wherein when obtaining the ID data, the service equipment further obtains and outputs a user parameter of the user to the server device, and the server device creates the service setting parameter according to the user parameter and the user model.

8. The method for operating a service recommendation system according to claim 7, wherein the user parameter is a physiological measurement data of the user.

9. The method for operating a service recommendation system according to claim 7, wherein the user parameter is a task parameter input by the user.

10. The method for operating a service recommendation system according to claim 1, wherein when obtaining the ID data, the service equipment further obtains and outputs a user parameter of the user to the server device, and the server device creates the service setting parameter according to the user parameter and the standard model.

11. The method for operating a service recommendation system according to claim 10, wherein the user parameter is a physiological measurement data of the user.

12. The method for operating a service recommendation system according to claim 10, wherein the user parameter is a task parameter input by the user.

13. The method for operating a service recommendation system according to claim 1, wherein the service equipment in operation further adjusts an execution time of the service setting parameter according to a physiological measurement data of the user.

14. A service recommendation system, at least comprising:
a label module, carried by a user, and having an identification (ID) data of the user;
at least one service equipment, comprising a detection module and a control interface for controlling an operating mode parameter of the service equipment, wherein the detection module obtains and outputs the ID data of the user; and
at least one server device, comprising a database, a determination module, and a service setting module, wherein the database stores at least one standard model and at least one user model, the determination module matches the ID data to the database, when the user model corresponding to the ID data exists in the database, the service setting module creates at least one service setting parameter according to the user model so as to set an operating mode of the service equipment, and when the user model corresponding to the ID data does not exist in the database, the service setting module creates the service setting parameter according to the standard model so as to set an operating mode of the service equipment.

15. The service recommendation system according to claim 14, wherein the service setting module generates the service setting parameter according to at least one condition contained in the user model of the database, and the condition comprises a history record of the user using the service equipment, a physiological measurement signal, a health condition information, an age, and a gender of the user.

16. The service recommendation system according to claim 15, wherein the condition is pre-stored in the database.

17. The service recommendation system according to claim 14, wherein the standard model is established based on average values of information related to a physiological measurement signal, a health condition information, an age, and a gender of users who have used service equipment and history records of the users using the service equipment.

18. The service recommendation system according to claim 14, wherein during the operating mode is enabled, the user initiatively sets the operating mode parameter of the control interface so as to adjust the operating mode of the service equipment.

19. The service recommendation system according to claim 18, wherein the service equipment returns a history record of the operating mode to the server device so as to store the history record in the database, and the server device updates the user model and the standard model according to the history record.

20. The service recommendation system according to claim 14, wherein when obtaining the ID data, the service equipment further obtains and outputs a user parameter of the user to the server device, and the server device creates the service setting parameter according to the user parameter and the user model.

21. The service recommendation system according to claim 20, wherein the user parameter is a physiological measurement data of the user.

22. The service recommendation system according to claim 20, wherein the user parameter is a task parameter input by the user.

23. The service recommendation system according to claim 14, wherein when obtaining the ID data, the service equipment further obtains and outputs a user parameter of the user to the server device, and the server device creates the service setting parameter according to the user parameter and the standard model.

24. The service recommendation system according to claim 23, wherein the user parameter is a physiological measurement data of the user.

25. The service recommendation system according to claim 23, wherein the user parameter is a task parameter input by the user.

26. The service recommendation system according to claim 14, wherein the service equipment in operation further adjusts an execution time of the service setting parameter according to a physiological measurement data of the user.

27. A device containing computer software loaded into an electronic device for executing an operating method of a service recommendation system, comprising:
obtaining an identification (ID) data of a user and transmitting the ID data to a server device by at least one service equipment;
matching the ID data to a database by the server device;
when a user model corresponding to the ID data exists in the database, creating at least one service setting parameter by the server device according to the user model, so as to set an operating mode of the service equipment; and
when a user model corresponding to the ID data does not exist in the database, creating at least one service setting parameter by the server device according to at least one standard model, so as to set an operating mode of the service equipment.

28. The device containing computer software according to claim 27, wherein the server device generates the service setting parameter according to at least one condition contained in the user model of the database, and the condition comprises a history record of the user using the service equipment, a physiological measurement signal, a health condition information, an age, and a gender of the user.

29. The device containing computer software according to claim 27, wherein the standard model is established based on average values of information related to a physiological measurement signal, a health condition information, an age, and a gender of users who have used service equipment and history records of the users using the service equipment.

30. The device containing computer software according to claim 27, wherein after the user uses the service equipment, the service equipment returns a history record of the operating mode to the server device, and the server device updates the user model and the standard model according to the history record.

31. The device containing computer software according to claim 27, wherein when obtaining the ID data, the service equipment further obtains and outputs a user parameter of the user to the server device, and the server device creates the service setting parameter according to the user parameter and the user model.

32. The device containing computer software according to claim 31, wherein the user parameter is a physiological measurement data of the user.

33. The device containing computer software according to claim 31, wherein the user parameter is a task parameter input by the user.

34. The device containing computer software according to claim 27, wherein when obtaining the ID data, the service equipment further obtains and outputs a user parameter of the user to the server device, and the server device creates the service setting parameter according to the user parameter and the standard model.

35. The device containing computer software according to claim 34, wherein the user parameter is a physiological measurement data of the user.

36. The device containing computer software according to claim 34, wherein the user parameter is a task parameter input by the user.

37. The device containing computer software according to claim 27, wherein the service equipment in operation further adjusts an execution time of the service setting parameter according to a physiological measurement data of the user.
